(19) United States
(12) Patent Application Publication
(10) Pub. No.: US 2019/0023400 A1
(43) Pub. Date: Jan. 24, 2019

(54) STORAGE COMPARTMENT FOR AN AIRCRAFT GALLEY

(71) Applicant: Sell GmbH, Herborn (DE)

(72) Inventors: Mario BITTER, Olpe (DE); Tim WALLBOTT, Lahnau (DE); Marcus JUNGE, Buxtehude (DE)

(21) Appl. No.: 16/072,944

(22) PCT Filed: May 3, 2017
(86) PCT No.: PCT/EP2017/060560

§ 371 Date: Jul. 26, 2018

Related U.S. Application Data
(60) Provisional application No. 62/331,743, filed on May 4, 2016.

(51) Int. Cl. B64D 11/04; B64D 11/00

(52) U.S. Cl. CPC B64D 11/04; A47B 88/402; B64D 11/0007

(57) ABSTRACT

The invention proposes a storage compartment device (1) for a galley of an aircraft, having a storage compartment (2) for receiving at least one rolling container (11) or at least one container (10, 25), wherein foldable guiding and holding devices (8) are provided in the storage compartment (2) and are designed to hold the at least one container (10, 25) in the storage compartment (2) only in a folded-out state and to allow the at least one rolling container (11) to be received in the storage compartment (2) only in a folded-in state. The invention additionally proposes a corresponding storage compartment system.

The present invention relates to a storage assembly for an aircraft galley in accordance with the type of independent claim 1. The subject matter of the invention is also a storage system for an aircraft galley according to claim 15.

### STATE OF THE ART

In modern aircraft, in particular in passenger aircraft, meals are carried along that are warmed in the on-board kitchen, also referred to as the galley, of the aircraft in a steam oven or convection oven and subsequently served to the passengers by the on-board personnel. During flight preparation, sealed meals in rolling containers, also referred to as trolleys, are brought into the galley. Storage assemblies with storage compartments, also referred to as compartments, are provided in the galley for securely storing the rolling containers during take-off, the in-flight phase and landing. Each rolling container with the sealed meals is pushed on its rollers into a respective compartment of a storage assembly and subsequently fixed in place. Such an oven of a galley is designed to accommodate one or multiple oven racks or oven inserts, also referred to as oven racks or oven inserts that are insertable and storable behind and on top of one another, and are able to accommodate a plurality of oven trays, also referred to as oven trays, with sealed meals. To heat the meals, the on-board personnel remove the sealed meals individually from the rolling containers, place them individually into the oven inserts and push the oven inserts loaded with the meals into the oven. The meals stored in the oven inserts are subsequently acted upon by steam and/or convection heat for heating in the oven. When the ovens are not in use, the oven inserts are generally stored in the oven and/or in special oven insert storage assemblies that, like the oven, are designed to hold oven inserts that are inserted behind and on top of one another in a storage compartment of the oven insert storage assembly.

The steps for heating meals in an aircraft galley described above are time-consuming. Moreover, the storage compartments for the rolling containers and the oven inserts must for safety reasons and provided in the galley occupy a large amount of storage space in the aircraft. In addition, in the case of short-distance flights and night flights with no meal preparation, the oven insert storage assemblies and thus their storage space frequently remain unused. In principle, however, the galley must be designed for long day flights with high frequency meal preparation and must therefore continuously have the maximum required number of oven insert storage assemblies. As a result, the tight space in the aircraft is not utilized efficiently.

### DISCLOSURE OF THE INVENTION

The object of the present invention is therefore to provide an improved storage assembly and an improved storage system for an aircraft galley that allow for more rapid service times when heating meals, as well as a better utilization of the storage space provided by the storage assemblies of the galley. In addition, it would be desirable if the storage assemblies of the galley could be flexibly reconfigured as a function of an temporary utilization scenario.

The object of the invention is attained by a storage assembly for an aircraft galley that includes the features of claim 1. The invention is based on the discovery that the amount of work for the on-board personnel may be reduced by eliminating the shifting of the meals to be heated from the rolling containers into the oven inserts. By reducing the amount of work, it is possible, depending on the service concept, to reduce the service time. For that to occur, the meals would already have to be in the oven inserts that are stowed in corresponding storage assemblies in the galley, upon completion of the flight preparation. If no meals are to be heated during the flight, then these storage assemblies need not accommodate any oven inserts with meals, but may rather be used for storing and securing rolling containers. Thus, the solution of the invention is a storage assembly having a storage compartment that may be modularly reconfigured and converted with little effort. According to the present invention, this same storage assembly is designed to accommodate at least one rolling container on the one hand and, after conversion by a user on the other hand, to accommodate and hold at least one container, in particular, an oven insert in the storage compartment.

This storage assembly includes a storage compartment designed as a receptacle into which at least one rolling container may be rolled in a first converted state, in order to be accommodated in the storage compartment. In a second converted state that differs from the first converted state, the storage compartment is designed to accommodate and hold at least one container. The container is, in particular, an oven insert. To provide the different converted states, foldable guiding and holding devices are provided in the storage compartment that may be alternatively set in a folded-in state and in a folded-out state. In the folded out state, the guiding and holding devices are designed to hold the at least one container in the storage compartment. Furthermore, in the folded-out state of the guiding and holding devices, the storage assembly is not designed to accommodate a rolling container. The guiding and holding devices in the folded-out state do not allow the rolling container to be introduced into the storage compartment. Only in the folded-in state is the at least one rolling container, in particular, exactly one full-size trolley or, at most, two half-size trolleys may be accommodated in the storage compartment.

The foldable guiding and holding devices make it possible for the storage compartment of the storage assembly according to the invention to be adapted by a user of the galley to current needs by a simple folding in or folding out of the guiding and holding devices. Thus, the space occupied by the storage assembly in the galley may be efficiently utilized. In addition, the storage assembly is very easily and flexibly reconfigurable.

The physical dimensions of the storage assembly are adapted to the rolling containers and containers established for galleys in passenger aircrafts. The rolling containers and containers conform without limitation, for example, to the standards established for galley components of passenger aircraft, such as ATLAS, KSSU, ACE or A-RINC 810.

A rolling container, also referred to as a trolley, is understood to mean a container fitted with rollers or wheels and movable on its wheels in the aircraft by on-board personnel. In the storage compartment, the at least one rolling container is accommodated by standing with its wheels on the floor of the storage container and being prevented by its brake device from rolling independently. The at least one rolling container is, for example, either a full-size trolley or two half-size trolleys, as defined by the above-mentioned standards. With respect to the number of half-size trolleys accommodated, it is necessary during take-off and landing for these to always fill one storage compartment completely.

A container is understood to mean one or multiple of the following elements: oven insert (synonyms: oven rack, oven insert), standard unit, drawer (synonym: drawer, container). The elements in this listing separated by commas embody different types of containers, in contrast to the cited respective synonyms. The container supportable by the guiding and holding devices, however, is preferably dimensioned according, but without limitation, to at least one of the above-mentioned standards or future standards.

In contrast to the at least one rolling container that may be accommodated in the storage compartment standing on its wheels, the at least one container is held in the storage container by the guiding and holding device in the folded-out state and provided on preferably opposite inner faces of side walls of the storage compartment. Thus, when inserting the at least one container into the storage compartment, the storage compartment is held and supported by the guiding and holding device provided preferably in pairs per container level. In the folded-in state, the guiding and holding devices are not designed to hold the at least one container. The guiding and holding device is preferably rail-like in design. One pair of guiding and holding devices provided on opposite inner faces of side walls of the storage compartment forms one insertion level for a container. The storage compartment provides preferably a plurality of such insertion levels. In addition, the storage compartment is preferably designed to accommodate and to hold two containers, preferably of the same type, inserted one behind the other in a same insertion level in the storage compartment.

In the folded-out state, the guiding and holding devices project farther from the inner faces of the side walls of the storage compartment than in the folded-in state. In the folded-in state, fold-out components of the guiding and holding devices abut as closely as possible the respective side wall. The guiding and holding devices extend preferably along the direction of insertion provided, in particular, in a horizontal direction or parallel to the floor of the galley. The guiding and holding devices are folded from the folded-in position to the folded-out position preferably via downward pivoting or lowering, i.e. toward the floor of the galley, by components of the guiding and holding devices that closely abut the inner faces of their respective walls in the folded-in state. The guiding and holding devices are folded from the folded-out position to the folded-in position preferably via upward pivoting or raising of components of the guiding and holding devices that, in the folded-out state, project further away from the inner faces of the respective walls than in their folded-in state.

In one refinement of the storage assembly, the guiding and holding devices in the folded-in state, preferably only in this state, each form a slide rail for guiding the at least one rolling container in the storage compartment. The slide rails allow for a simple insertion of the at least one rolling container into the storage compartment and, at the same time, serve to limit the width of the chamber of the storage compartment to fit the width of the rolling container.

In one refinement of the storage assembly, the guiding and holding devices each include a support and preferably a support body associated with the support. In the folded-out state, preferably only in this state, of each guiding and holding device, each support is designed to hold one container. Furthermore, the support in the folded-out state is also designed as a guide rail for guiding the container during insertion of the container into the storage compartment. The support is designed to support the support body in the folded-out state on an inner face of a side wall of the storage compartment. The support may be formed by a plate extending longitudinally in the insertion direction of the container, which is also a leaf or a plate of a hinge. The support may be formed by a section of an, in particular, angled plate that runs along the support and is fastened thereto or is integrated therewith. The slide rail of the refinement mentioned in the preceding paragraph may be mounted on the angled plate and/or on a surface of the support not provided for holding the container. The slide rail may also be designed as the support in such a way that, in the folded-out state of the guiding and holding device, the slide rail is pressed against a section of the inner face of a side wall of the storage compartment by the support and thereby supports the support body by means of the inner face of a side wall acting as a counter-bearing. The loads absorbable by the support are increased by the support.

In one refinement of the storage compartment, the guiding and holding devices each include a hinge having a first leaf (synonym: blade) fixed to an inner face of a side wall of the storage compartment and a second leaf rotatable about a hinge axis relative to the first leaf. The second leaf is designed in the folded-out state of the respective guiding and holding device to carry the at least one container. In the folded-in state, the second leaf is the above-mentioned slide rail for guiding the at least one rolling container. The hinge axis extends preferably along the insertion direction provided for the container and, therefore in an at least approximately horizontal direction. This refinement may be implemented with simple means. In addition, the first leaf of such a guiding and holding device may be very simply mounted on an inner face of a side wall of a conventional storage assembly. For this reason, existing storage assemblies, after a previous successful test for convertibility, may be efficiently converted in terms of use and thus may continue to be used with enhanced flexibility and convertibility.

In one refinement of the storage assembly, at least one of the foldable guiding and holding devices is provided with an integrated stop for the at least one container accommodated in the storage compartment. Preferably at least one, particularly preferably both guiding and holding devices provided in pairs per insertion level in the storage compartment, are provided with such an integrated stop. The stop is designed and provided in order to limit the insertion depth of the (possibly rear) container in the storage compartment in such a way that the front side of the (possibly other forward) container may be brought into a desired position. The stop is preferably integrated into the guiding and holding device in such a way that it acts, and is thus active, as a stop only in the folded-out state of the guiding and holding device, and in the folded-in state of the guiding and holding device does not project into the chamber and is therefore inactive. In addition, the stop is preferably designed to be foldable so that it may be folded from an active state into the inactive state. The stop is particularly preferably integrated into or with the guiding and holding device in such a way that the stop is set in its active state when the guiding and holding device is folded into the folded-out state and, in addition, is deactivatable from its active state by folding the stop relative to the guiding and holding device that remains in the folded-out state. The folding of the stop is understood to mean both a pivotal movement of the stop as well as a pulling out or pressing in of a stop relative to an inner face of a side wall of the storage compartment. The latter preferred refinement allows for a simple extension of the insertion depth if containers having a lesser depth such as, for example, two oven inserts inserted one behind the other, and only rarely (in this case after a preceding folding or deactivation of the integrated stop) containers having a greater insertion depth such as, for example, two standard units inserted one behind the other, are introduced into the storage compartment on the same pair of guiding and holding devices. Thus, the storage compartment may be simply converted for the alternative use of oven inserts or standard units by activating or deactivating the integrated stop. The same applies for drawers that are preferably introduced in pairs per insertion level into the storage compartment, wherein an activatable or deactivatable stop is provided for the initially introduced rear draw at a suitable depth position.

In one refinement of the storage assembly two or more preferably foldable stops having container-specific insertion depths relative to one another are provided in the storage compartment for at least one insertion level of the foldable guiding and holding devices. The folding of the stop is understood to mean an arbitrarily designed change from an active state to a inactive state and in reverse direction. As in the last-mentioned refinement, the storage compartment may therefore be simply converted for the alternative use of oven inserts or standard units or drawers by activating or deactivating the different stops per insertion level.

In one refinement of the storage compartment, the storage assembly is designed to accommodate and hold containers provided one behind the other, in particular, exactly two containers, preferably of the same type, per insertion level formed by the guiding and holding devices provided in pairs. This refinement further preferably comprises a pull-out device for pulling out a rear container accommodated in the storage compartment. This allows in general for an improved handling and, in particular, a rapid and convenient emptying of the storage assembly. Because of the rapid emptying, the storage assembly may also be especially rapidly converted by an immediately subsequent folding of the guiding and holding devices.

In one refinement of the storage assembly, the storage compartment may be converted for a user from the rolling container receptacle to the container receptacle and in the reversed conversion direction without the use of tools. The storage assembly may be converted from the rolling container receptacle to the container receptacle and vice versa without the use of tools, in particular, without adding or removing components to or from the storage assembly. Thus, the storage assembly may be rapidly and flexibly converted.

In one refinement of the storage compartment, the storage assembly includes a mechanism for automatically setting the guiding and holding device in the folded-in state after removal of a container held by it from the storage compartment when these guiding and holding devices then instantaneously no longer hold or are intended to hold any other containers. This mechanism is preferably designed for setting all of the guiding and holding devices in the folded-in state, if no container is accommodated and held any longer in the storage compartment. This setting particularly preferably takes place automatically in response to a removal from the storage compartment of the last container accommodated in the storage compartment. This increases the user convenience, since, thanks to the automated conversion, a user is able to insert a rolling container into the storage compartment immediately after removing the last container. This mechanism further protects the storage assembly, the folded-out guiding and holding elements of which would be damaged when inserting a rolling container into the empty storage compartment.

In one refinement of the storage compartment, the storage assembly includes a mechanism for automatically setting the guiding and holding device in the folded-out state. This allows for a rapid conversion of an empty storage compartment for receiving and holding containers.

In one refinement of the storage compartment, the guiding and holding devices are purely mechanically foldable during normal operation, i.e. without the assistance or control of an electrical or electronic unit. This ensures long maintenance intervals and a low susceptibility to errors of the storage assembly.

In one refinement of the storage assembly, the storage compartment accommodates a full-size trolley or half-size trolley for an aircraft galley, when all guiding and holding devices are in the folded-in state. The storage compartment is designed to accommodate at least exactly one full-size trolley. In the case of a galley having a total depth extending beyond the insertion depth of a full-size trolley, the storage assembly is provided with a storage compartment, into which as many full-size trolleys and/or half-size trolleys may be inserted as allowed by the total depth of the galley.

In one refinement of the storage assembly, the at least one container is provided for an aircraft galley, and is preferably a type of oven insert, a standard unit or a drawer. The storage compartment is preferably designed to accommodate at least two containers of the same type per insertion level of the storage compartment, and a plurality of guiding and holding devices are provided in the storage compartment for providing a plurality of insertion levels.

In one refinement of the storage assembly, the guiding and holding devices form multiple insertion levels for containers in the storage compartment and are provided to accommodate and to hold a plurality of containers of a first type, in particular, of oven inserts, and a plurality of containers of a second type that differs from the first type, in particular, drawers. Because different container types may be accommodated in the storage compartment, this results in greater convenience for the user and great flexibility. A storage assembly having guiding and holding devices for implementing three insertion levels for accommodating a total of six oven inserts and for implementing an insertion level for accommodating two drawers enables a particularly efficient utilization of the storage compartment.

The object of the invention is also achieved by a storage system for an aircraft galley having at least one of the above storage assemblies and having at least one rolling container accommodated in the at least one storage assembly, wherein all guiding and holding devices of the storage assembly are in the folded-in state, or having one or multiple containers that are, in particular, oven inserts, standard units and/or drawers, accommodated in the at least one storage assembly and held by the guiding and holding devices set in the folded-out state.

The invention comprises arbitrary combinations of the refinements described above.

### BRIEF DESCRIPTION OF THE DRAWINGS

To illustrate the proposed storage assembly, embodiments are now with reference to the following figures.

FIG. 1 schematically illustrates an embodiment of the storage assembly with oven inserts accommodated and held therein.

FIG. 2 schematically illustrates an embodiment of the storage assembly with a rolling container accommodated therein.

FIG. 3 is a perspective view of an embodiment of the storage assembly that is configured to accommodate containers on three insertion levels.

FIG. 4 is a perspective view of the storage assembly illustrated in FIG. 3 with six oven inserts accommodated therein.

FIG. 5 is a perspective view of the embodiment of the storage assembly of FIG. 3 and FIG. 4 after conversion to accommodate a rolling container.

FIG. 6 is a perspective view of the storage assembly illustrated in FIG. 5 with a rolling container accommodated therein.

FIG. 7 is a perspective detailed view of a guiding and holding device of an embodiment of the storage assembly in the folded-out state.

FIG. 8 is a perspective detailed view of the guiding and holding device of the embodiment of the storage assembly previously shown in FIG. 7 in the folded-in state.

FIG. 9 is a perspective view of an embodiment of the storage assembly having a storage compartment with four insertion levels that are occupied by six oven inserts and two drawers.

FIG. 10 shows a perspective view of the embodiment of FIG. 9, wherein four insertion levels in the storage compartment are occupied by four oven inserts and four drawers.

In all these figures, identical or similar components are designated with the same reference numerals.

### EMBODIMENTS OF THE INVENTION

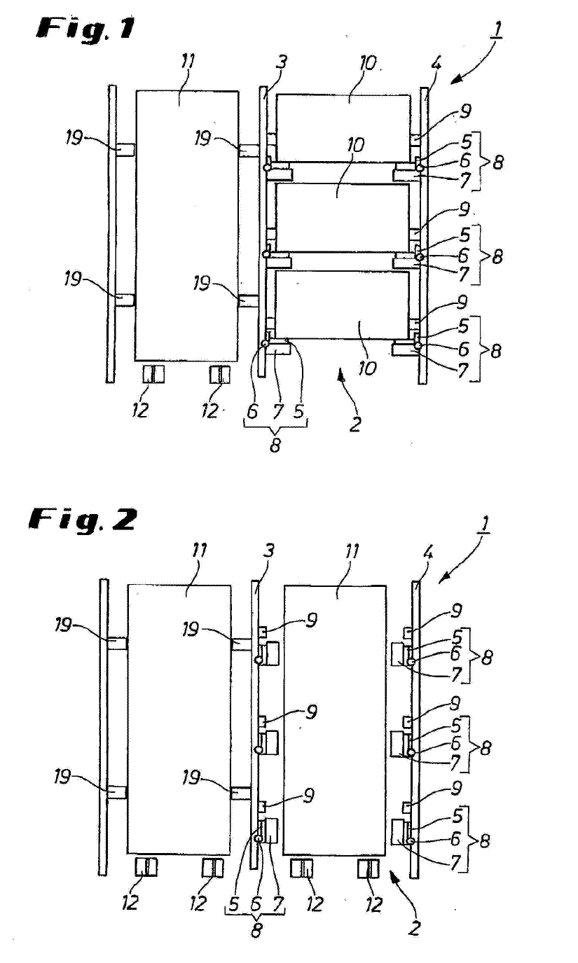

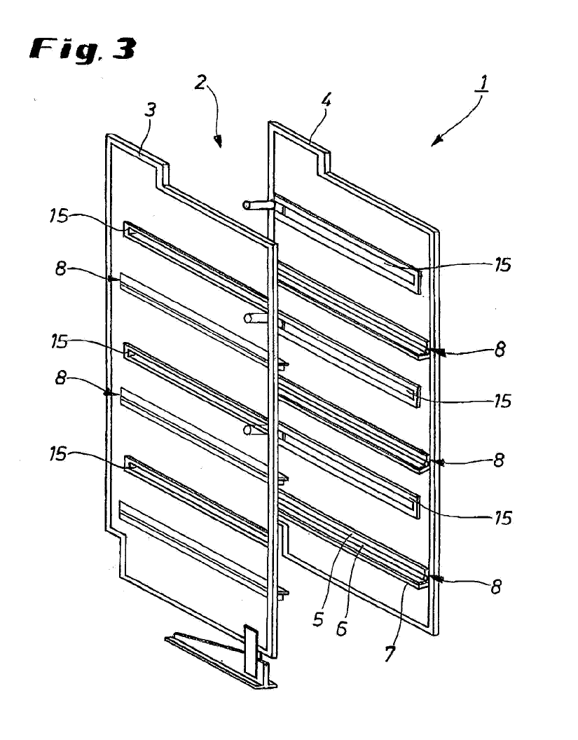

FIGS. 1 and 2 schematically illustrate one embodiment of a convertible storage assembly. The storage assembly 1 illustrated in FIG. 1 can accommodate and hold multiple containers in its storage compartment 2. Each of the containers is an oven insert 10 according to a common standard cited above. Three guiding and holding devices 8, which are all in the folded-out state, are provided on the inside face of each of the two side walls 3 and 4 of the storage compartment 2. Each guiding and holding device 8 comprises a support 5, a hinge 6 and a slide rail 7. Two of the guiding and holding devices 8 are mounted in pairs at a common insertion height on the opposing inner faces of the side walls 3 and 4 of the storage compartment and each pair defines an insertion level of the storage compartment. Accordingly, the storage assembly 1 of FIG. 1 has three insertion levels each for accommodating and holding a maximum of two oven inserts 10. The oven inserts 10 are held and supported in the storage compartment 2 by the supports 5 that project into the chamber of the storage compartment 2, or sit on these supports. The slide rails 7 of the guiding and holding device are directed toward the lower bottom of the storage compartment 2 and serve preferably to brace their supports 5 on the adjoining inner face of a side wall 3 or 4. Respective guiding and slide rails 9 are also provided on the inner faces of the side walls 3 and 4 for each insertion level and are spaced to match the width of the oven inserts 10.

The storage assembly illustrated in FIG. 2 shows the storage assembly 1 previously illustrated in FIG. 1 after being converted to accommodate a rolling container. A rolling container 11 that is supported by its wheels 12 on floor under the storage compartment 2 and is accommodated in the storage compartment 2 of the storage assembly. All the guiding and holding devices 8 are in their folded-in state. The supports 5 closely abut the inner faces of the side walls 3 or 4. The slide rails 7 are folded in against the side walls of the rolling container 11 and are accordingly positioned for guiding and limiting movement of the rolling container 11 in the storage compartment 2.

Adjacent the side wall 3 of the storage compartment 2 of the described embodiment is an illustrated non-convertible storage compartment with a rolling container 11 accommodated therein and guided by rails 19 and that is structurally identical to the rolling container 11 of FIG. 2 in the convertible storage compartment 2 according to the invention.

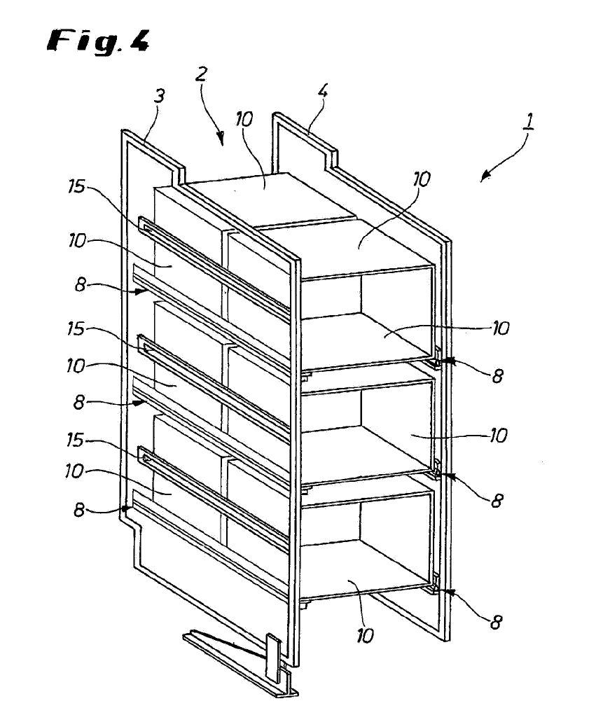

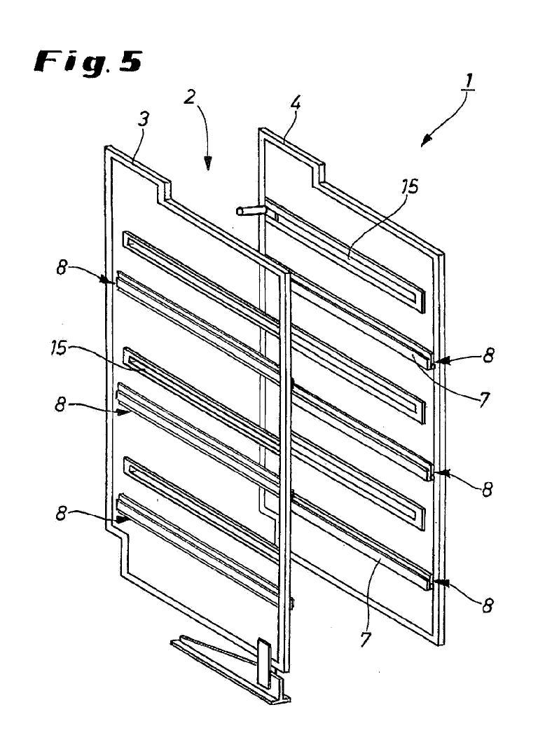

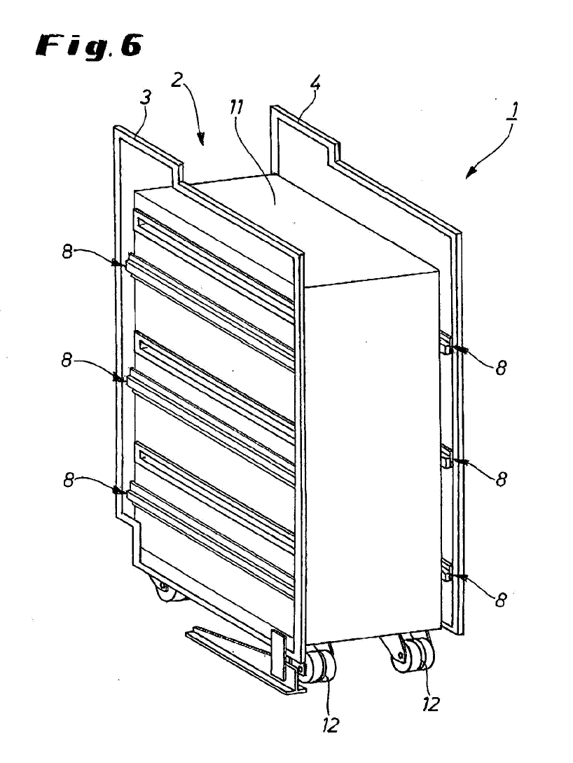

An embodiment of the storage assembly is illustrated in perspective in FIG. 3 through FIG. 6. FIG. 3 and FIG. 4 serve to illustrate the storage assembly 1 configured to accommodate and hold oven inserts. All the guiding and holding devices 8 are in the folded-out position. In addition to the components previously described with respect to the embodiment of FIG. 1 and FIG. 2, the storage assembly 1 of FIG. 3 through FIG. 6 is provided with two pull-out devices 15 per insertion level for pulling out a rear container accommodated in the storage compartment 2. FIG. 5 and FIG. 6 serve to illustrate the storage assembly 1 configured to accommodate a rolling container. All the guiding and holding devices 8 are in the folded-in position. FIG. 6 shows the limitation on movement of the rolling container 2 in the storage compartment 2 by the slide rails of the folded-in guiding and holding devices 8.

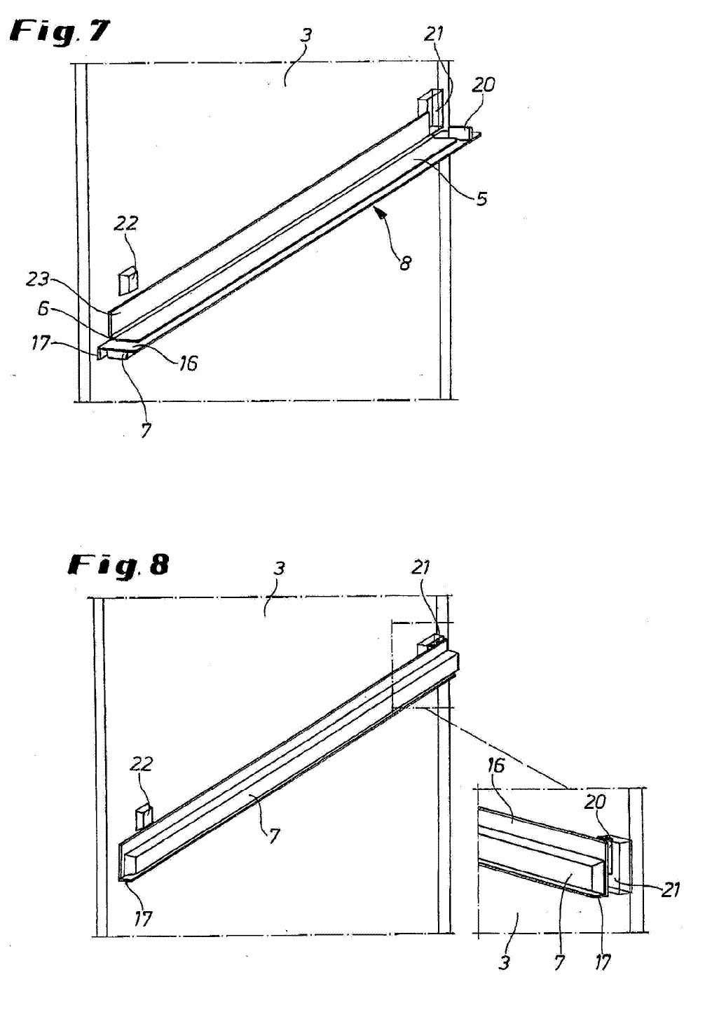

FIGS. 7 and 8 show perspective detailed views of a guiding and holding device 8 according to one embodiment in the folded-out and in the folded-in state. The guiding and holding device 8 illustrated in FIG. 7 and FIG. 8 has the hinge 6 with a rotation axis extending horizontally in the insertion direction, having a first leaf 23 and a second leaf that is a support 5 for holding a container accommodated in the storage compartment. When transitioning from the folded-in state to the folded-out state, the support 5 is pivoted downward by rotation. In the folded-out state, the support 5 is also designed as a guide rail for guiding the container when the container is inserted into the storage compartment. The first and the second leaf are designed as plates extending along the insertion direction. The first leaf is mounted on the inner face of a side wall 3 of the storage compartment. Fixed to the second leaf constituting the support 5 is an orthogonally angled plate 16 having a segment designed as a support body 17. The support body 17 extending orthogonally to the support 5 is designed to carry the support 5 in the folded-out state on the adjacent wall 3 of the storage compartment. The slide rail 7 that, like the first and second leaves, extends longitudinally in the direction of the insertion direction, is attached on a side of the angled plate 16 facing away from the support 5. Located In the region of the front end of the guiding and holding device 8 is a detent 22 for preventing a container from falling out of the storage compartment of the storage assembly. This detent is provided at a rear end of the guiding and holding device 8 with an integrated stop 20 that is a stop buffer and serves for restricting the insertion depth of a container that has been inserted into the storage compartment on the support 5. The side wall 3 is provided with an indentation or recess 21 in the area surrounding the rear end of the guiding and holding device 8. This recess is shown in magnified view in FIG. 8. The recess 21 is designed to accommodate the stop 20 in the folded-in state of the guiding and holding device 8 so that the stop does not project into the chamber of the storage compartment and is therefore inactive. In the folded-in state of the guiding and holding device 8 shown in FIG. 8, the first and the second leaves lie as close as possible on one another, and the slide rail 7 projects into the storage compartment for guiding movements of a rolling container in the storage compartment.

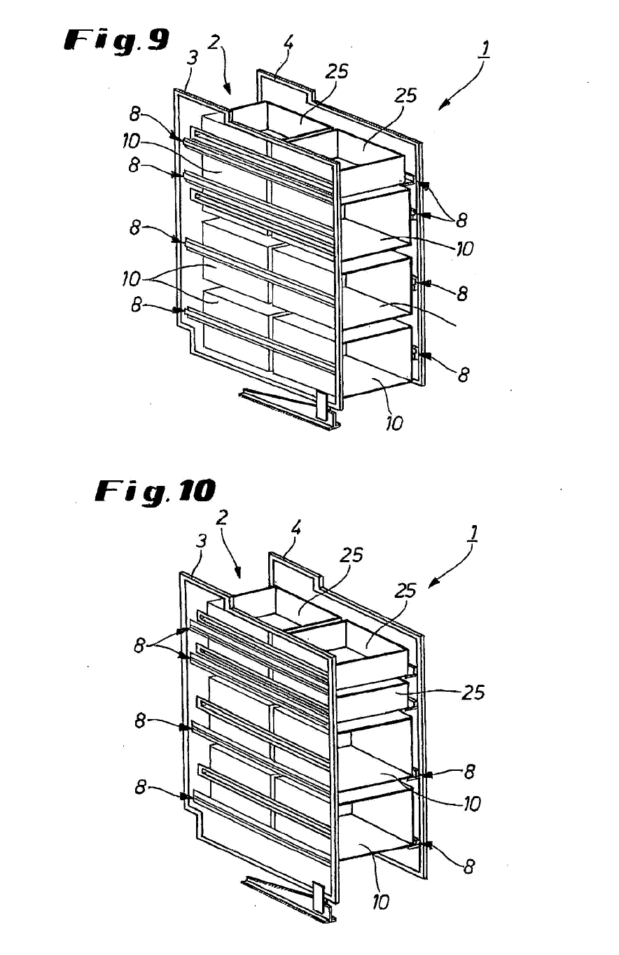

An embodiment of a storage assembly is illustrated in perspective in FIGS. 9 and 10. The storage assembly is provided with eight guiding and holding devices 8 in four different heights of the storage compartment 2. In the equipping of the storage assembly shown in FIG. 9, six oven inserts 10 are held laterally by the associated lower six guiding and holding devices 8. In contrast, the upper two guiding and holding devices 8 support two drawers 25, one behind the other. In the equipping of the same storage assembly as in FIG. 9 shown in FIG. 10, all eight guiding and holding devices 8 have an additional supporting function for four oven inserts 10 as well as four drawers 25 without the oven inserts 10 being held laterally as shown in FIG. 9. Because the storage assembly of FIGS. 9 and 10 is alternatively designed for laterally holding or for supporting the oven inserts 10, it means that the storage compartment may be flexibly adapted to the required use.

The foregoing embodiments may also be designed for selective accommodation of oven inserts or standard units or drawers. Since the standard units have a different insertion depth into the storage compartment than the oven inserts, the storage assembly, in addition to the integrated stop that is adapted to the insertion depth of the oven inserts/standard units, includes per insertion level an additional foldable stop in the storage compartment that is adapted to the insertion depth of the standard units/oven inserts. In the case of a design for selectively accommodating drawers, a foldable stop may be provided in the storage compartment that is adapted to the insertion depth of each drawer.

All illustrated and described embodiments of the storage assembly according to the invention are convertible from the rolling container receptacle configuration to the container receptacle configuration and vice versa by a user without the use of tools, without having to add components to or to remove components from the storage assembly.

List of Reference Numerals

| | |
|---|---|
| 1 | storage assembly |
| 2 | storage compartment |
| 3, 4 | inner face of a side wall |
| 5 | support |
| 6 | hinge |
| 7 | slide rail |
| 8 | guiding and holding device |
| 9 | guiding and slide rails |
| 10 | oven insert |
| 11 | rolling container |
| 12 | wheels |
| 15 | pull-out device |
| 16 | plate |
| 17 | support |
| 19 | guide rail |
| 20 | integrated stop |
| 21 | recess |
| 22 | detent |
| 23 | leaf |
| 25 | drawer |

1. A storage compartment of a storage assembly for an aircraft galley, the storage compartment comprising, for accommodating at least one rolling container or at least one container:
foldable guiding and holding devices movable between a fold-out state supporting the at least one container in the storage compartment and a folded-in state holding the at least one rolling container in the storage compartment.

2. The storage compartment according to claim 1, wherein the guiding and holding devices in the folded-in state each form a slide rail for guiding the at least one rolling container in the storage compartment.

3. The storage compartment according to claim 1, wherein the guiding and holding devices each include a support, and in the folded-out state of the respective guiding and holding device, the respective support for holding a container is on an inner surface of a wall of the storage compartment.

4. The storage compartment according to claim 1, wherein guiding and holding devices each include a hinge having a first leaf fixed to an inner face of a side wall of the storage compartment and a second leaf rotatable about a hinge axis relative to the first leaf, and the second leaf in the folded-out state of the respective guiding and holding device holds the at least one container and is a slide rail for guiding the at least one rolling container.

5. The storage compartment according to claim 1, wherein at least one of the foldable guiding and holding devices is provided with an integrated stop for the at least one container.

6. The storage compartment according to claim 1, wherein two or more stops having container-specific insertion depths different from one another are provided in the storage compartment for at least one insertion level of the foldable guiding and holding devices.

7. The storage compartment according to claim 1, wherein the storage compartment accommodates and holds containers one behind the other, and further comprises at least one pull-out device for pulling out a rear container in the storage compartment.

8. The storage compartment according to claim 1, wherein the storage compartment is convertible by a user from the rolling container receptacle to the container receptacle and vice versa without the addition of components or removal of components and without the use of tools.

9. The storage compartment according to claim 1, wherein the storage assembly includes a mechanism for setting the guiding and holding devices in the folded-in state after removal of a container held by this guiding and holding device from the storage compartment.

10. The storage compartment according to claim 1, wherein the storage assembly includes a mechanism for automatically setting the guiding and holding devices in the folded-out state.

11. The storage compartment according to claim 1, wherein the guiding and holding devices are purely mechanically foldable during normal operation.

12. The storage compartment according to claim 1, wherein the storage compartment is designed to accommodate exactly one full-size trolley or at most two half-size trolleys for an aircraft galley, when all guiding and holding devices are in the folded-in state.

13. The storage compartment according to claim 1, wherein the at least one container is provided for an aircraft galley, and is an oven insert, a standard unit and/or a drawer.

14. The storage compartment according to claim 1, wherein the guiding and holding devices are provided in the storage compartment to accommodate and hold a plurality of containers of a first type of oven inserts, and a plurality of containers of a second type differing from the first type of drawers.

15. A storage system for an aircraft galley, comprising at least one storage assembly according to claim 1 and comprising at least one rolling container accommodated in the at least one storage assembly, and all of the guiding and holding devices of the storage assembly are in the folded-in state, or comprising one or multiple containers accommodated in the at least one storage assembly and held by the guiding and holding devices set in the folded-out state that are, in particular, oven inserts, standard units and/or drawers.
